(19) United States
(12) Patent Application Publication
(10) Pub. No.: US 2004/0115497 A1
(43) Pub. Date: Jun. 17, 2004

(54) Control device for fuel cell

(76) Inventor: Keisuke Suzuki, Kanagawa (JP)

Correspondence Address: Richard L Schwaab, Foley & Lardner, Washington Harbour Suite 500, 3000 K Street NW, Washington, DC, 20007-5109, US

(21) Appl. No.: 10/469,544

(22) PCT Filed: Dec. 24, 2002
(86) PCT No.: PCT/JP02/13439

(30) Foreign Application Priority Data
Jan. 17, 2002 (JP) 2002008762

(51) Int. Cl. H01M 8/04

(52) U.S. Cl. 429/25

(57) ABSTRACT

A fuel cell stopping procedure start judgment unit (101) judges a start of procedures for stopping a fuel cell. A fuel electrode gas controlling unit (102) controls fuel gas at a fuel electrode toward a stopping state based on the judgment of the start of the stopping procedures. A gas pressure detecting unit (103) detects gas pressure at the fuel electrode. An oxidant electrode gas controlling unit (104) controls gas pressure at an oxidant electrode such that a difference between the gas pressure at the oxidant electrode and the gas pressure at the fuel electrode falls within a maximum value of an allowable pressure difference based on a result of the gas detection and an output from the fuel cell stopping procedure start judgment unit (101), and also controls the gas pressure at the oxidant electrode to atmospheric pressure after the gas pressure detected by the gas pressure detecting unit reaches a sum of the atmospheric pressure and the maximum value of the allowable pressure difference.

### TECHNICAL FIELD

The present invention relates to a control device for a fuel cell, more specifically, to controlling gas pressure upon stopping the fuel cell.

### BACKGROUND ART

Upon stopping a fuel cell, it is necessary to stop gas for a fuel electrode and gas for an oxidant electrode promptly, while preventing occurrence of deterioration in the fuel cell attributable to an increase in internal resistance of the fuel electrode thereafter and an increase in a pressure difference between the fuel electrode and the oxidant electrode.

Japanese Unexamined Patent Publication No. 2000-512069 discloses a technology (hereinafter, referred to as a first prior art) for preventing gradual deterioration of an electrolyte, which is attributable to a variation of distribution of electric current density caused by an increase in internal resistance of the cell owing to formation of an oxide coating by excessive oxygen, by means of closing a supply valve on an oxidant electrode side, and then closing a supply valve on a fuel electrode side when partial pressure of oxygen on the oxidant electrode side falls down to a predetermined value in the event of stopping a fuel cell.

Meanwhile, Japanese Unexamined Patent Publication No. 8(1996)-45527 discloses a technology (hereinafter, referred to as a second prior art) for preventing an increase in a pressure difference between a fuel electrode and an oxidant electrode upon emergency stop of a fuel cell designed to supply reformed gas from a fuel reformer, by means of continuing gas supply to the oxidant electrode while continuing rotation of an air blower for a predetermined time period.

### DISCLOSURE OF INVENTION

However, the gas for the oxidant electrode is stopped beforehand in the first prior art. Accordingly, in a constitution for supplying oxidant gas typically composed of a compressor and a pressure regulation valve, gas pressure on the oxidant electrode side suddenly drops and a pressure difference between gas pressure on the fuel electrode side still in operation and the gas pressure on the oxidant electrode side resultantly becomes excessive. Therefore, the first prior art has a problem of bearing a risk of deteriorating the electrolyte.

Meanwhile, continuation of the gas supply for the oxidant electrode upon stopping the fuel cell is controlled with a timer in the second prior art. However, a variation of the pressure difference between gas pressure at the fuel electrode and gas pressure at the oxidant electrode may fluctuate depending on an operating condition in the event of stopping the fuel cell. Accordingly, there is no guarantee that the pressure difference is maintained within tolerance after stopping the gas supply to the oxidant electrode in spite of controlling with the timer and the pressure difference between the fuel electrode and the oxidant electrode may become excessive as similar to the first prior art. Therefore, the second prior art also has the problem of bearing a risk of deteriorating the electrolyte.

In consideration of the foregoing problem, it is an object of the present invention to provide a control device for a fuel cell capable of maintaining a pressure difference between a fuel electrode and an oxidant electrode within tolerance upon stopping the fuel cell and thereby eliminating a risk of deteriorating an electrolyte therein.

To attain the foregoing object, the present invention provides a control device for a fuel cell including a fuel cell stopping procedure start judgment unit for judging a start of procedures for stopping a fuel cell, a fuel electrode gas controlling unit for controlling fuel gas at a fuel electrode toward a stopping state based on an output from the fuel cell stopping procedure start judgment unit, a gas pressure detecting unit for detecting gas pressure at the fuel electrode, and an oxidant electrode gas controlling unit for controlling gas pressure at an oxidant electrode such that a difference between the gas pressure at the oxidant electrode and the gas pressure at the fuel electrode falls within a maximum value of an allowable pressure difference based on an output from the gas pressure detecting unit and the output from the fuel cell stopping procedure start judgment unit, and for controlling the gas pressure at the oxidant electrode to atmospheric pressure after the gas pressure detected by the gas pressure detecting unit reaches a sum of the atmospheric pressure and the maximum value of the allowable pressure difference.

### BRIEF DESCRIPTION OF DRAWINGS

FIG. 1 is a basic constitutional view of a control device for a fuel cell according to the present invention.

FIG. 2 is a constitutional view of hardware of a fuel cell system adopting an embodiment of the present invention.

FIG. 3 is a timing chart showing a variation of gas pressure with time in the event of stopping a fuel cell which does not adopt the present invention.

FIG. 4 is a timing chart showing a variation of gas pressure with time in the event of stopping a fuel cell which adopts the present invention.

FIG. 5 is a general flowchart for explaining an operation of a controller according to the embodiment.

FIG. 6 is a detailed flowchart for explaining procedures for stopping hydrogen control according to the embodiment.

FIG. 7 is another detailed flowchart for explaining the procedures for stopping hydrogen control according to the embodiment.

FIG. 8 is a detailed flowchart for explaining procedures for air controlling according to the embodiment.

### BEST MODE FOR CARRYING OUT THE INVENTION

Now, description will be made in detail regarding embodiment of a control device for a fuel cell according to the present invention with reference to the accompanying drawings.

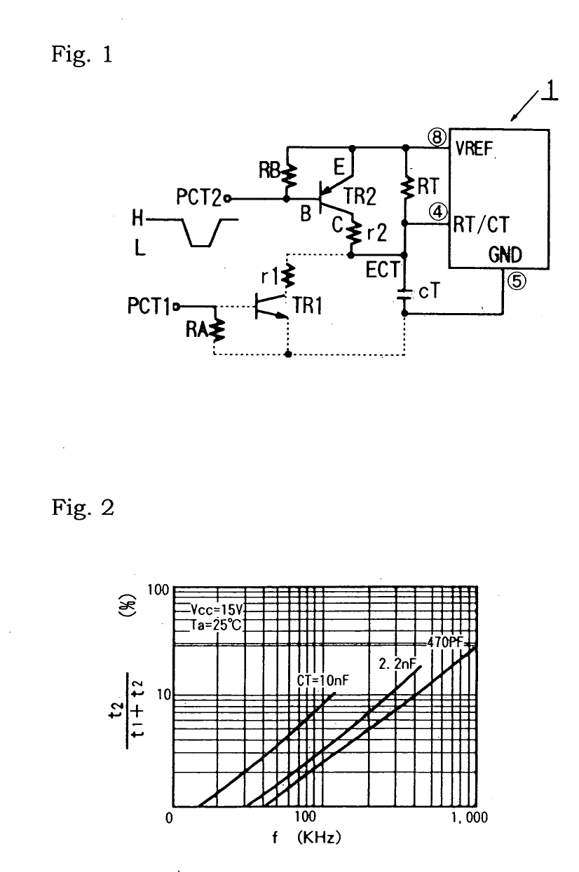

In FIG. 1, a control device for a fuel cell includes a fuel cell stopping procedure start judgment unit 101 for judging a start of procedures for stopping a fuel cell, a fuel electrode gas controlling unit 102 for controlling fuel gas at a fuel electrode toward a stopping state based on an output from the fuel cell stopping procedure start judgment unit 101, a gas pressure detecting unit 103 for detecting gas pressure at the fuel electrode, and an oxidant electrode gas controlling unit 104 for controlling gas pressure at an oxidant electrode such that a difference between the gas pressure at the oxidant electrode and the gas pressure at the fuel electrode falls within a maximum value of an allowable pressure difference based on an output from the gas pressure detecting unit 103 and the output from the fuel cell stopping procedure start judgment unit 101, and for controlling the gas pressure at the oxidant electrode to atmospheric pressure after the gas pressure detected by the gas pressure detecting unit reaches a sum of the atmospheric pressure and the maximum value of the allowable pressure difference.

FIG. 2 is a constitutional view of hardware of a fuel cell system adopting an embodiment of the control device for a fuel cell according to the present invention. Here, the fuel cell is applied to a power source for a fuel cell vehicle or a hybrid vehicle including a fuel cell.

As shown in FIG. 2, the fuel cell system includes a fuel cell stack 201 which is a fuel cell body including an air electrode 201a as an oxidant electrode and a fuel electrode 201b, a humidifier 202, a compressor 203, a high-pressure hydrogen tank 215 for storing hydrogen gas as fuel, a variable valve 204 for controlling a flow rate of the high-pressure hydrogen, a throttle 205 for controlling pressure and a flow rate of the air, a purge valve 206 for discharging hydrogen outward, a purified water pump 207, an ejector 208 for circulating unused hydrogen discharged from the fuel cell stack 201 back to an upstream, a driving unit 209 for taking an output out of the fuel cell stack 201, an air pressure sensor 210 for detecting air pressure at a fuel cell inlet, a hydrogen pressure sensor 211 for detecting hydrogen pressure at the fuel cell inlet, an air flow rate sensor 212 for detecting a flow rate of the air flowing into the fuel cell, a hydrogen flow rate sensor 213 for detecting the flow rate of hydrogen flowing into the fuel cell, and a controller 214 for retrieving signals of the respective sensors 210, 211, 212 and 213 and for controlling the respective actuators (203, 204, 205 and 206) of the fuel cell based on built-in controlling software.

The compressor 203 compresses and sends the air to the humidifier 202, and the humidifier 202 humidifies the air with purified water supplied from the purified water pump 207. The humidified air is sent to the fuel cell stack 201.

The flow rate of the hydrogen gas stored in the high-pressure hydrogen tank 215 is controlled by the variable valve 204, and the hydrogen gas merges with exhaust gas from the fuel electrode 201b at the injector 208. The merged gas is sent to the humidifier 202. The humidifier 202 humidifies the hydrogen with the purified water supplied from the purified water pump 207 as similar to the air, and the humidified hydrogen is sent to the fuel electrode 201b of the fuel cell stack 201. The fuel cell stack 201 generates electricity by promoting a reaction between the air and the hydrogen sent thereto, and supplies an electric current (electric power) to the driving unit 209.

The remainder of the air after the reaction at the fuel cell stack 201 is discharged out of the fuel cell. The pressure of the air is regulated by the throttle 205 and the air is discharged to the atmosphere. Meanwhile, the remainder of the hydrogen after the reaction is also discharged out of the fuel cell, but is circulated back to the upstream of the humidifier 202 by the ejector 208 and reused for power generation.

The controller 214 retrieves the detected values severally from the air pressure sensor 210 for detecting the air pressure at the inlet of the air electrode 201a, the air flow rate sensor 212 for detecting the flow rate of the air, the hydrogen pressure sensor 211 for detecting the hydrogen pressure at the inlet of the fuel electrode 201b, and the hydrogen flow rate sensor 213 for detecting the flow rate of the hydrogen. Subsequently, the controller 214 controls the compressor 203, the throttle 205 and the variable valve 204 such that the detected values thus retrieved are severally set to given target values determined by a target generation amount of electricity at that time. Moreover, the controller 214 instructs and controls an output (an electric current value) to be taken out of the fuel cell stack 201 to the driving unit 209 in response to the pressure and the flow rates actually achieved with respect to the target values.

Furthermore, the controller 214 includes the fuel cell stopping procedure start judgment unit 101, the fuel electrode gas controlling unit 102 and the oxidant electrode gas controlling unit 104 as shown in FIG. 1.

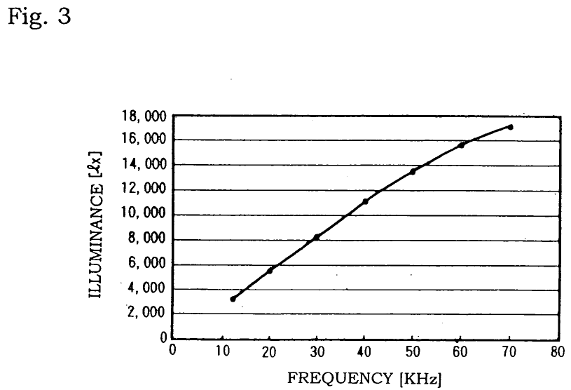

In the fuel cell having the constitution as shown in FIG. 2 except controlling by the controller 214, aspects of variations of the hydrogen pressure at the fuel electrode and of the air pressure at the air electrode with time in the event of stopping the fuel cell not adopting the present invention are shown in a timing chart in FIG. 3.

Now, let us assume that a condition for judging a start of procedures for stopping the fuel cell occurs for some reason at a time point t0 when the fuel cell is in operation, for example. Judgment is made to stop supplying the air and the hydrogen at that time point (t0). In response to the judgment, the compressor 203 is stopped and the throttle 205 is fully opened regarding an air system. Meanwhile, the variable valve 204 is closed and the purge valve 206 is fully opened regarding a hydrogen system. In this way, the air pressure at the air electrode falls off quickly as indicated with a dotted line in FIG. 3.

On the other hand, since the purge valve 206 provided for preventing he output from failing off due to a water block or the like has a small flow rate, the hydrogen pressure at the fuel electrode falls off gently as indicated with a solid line in FIG. 3. It is attributable to the fact that the purge valve is provided with a minimum flow rate required for discharging blocking water in order to avoid occurrence of a sudden drop of pressure upon purging during the operation.

There is also a case upon stopping the fuel cell where the purge valve is not opened immediately. Instead, the purge valve is controlled to be fully opened after an exhaust gas processor, which processes the hydrogen gas to be discharged, is set ready for operation. In such a case, the drop in the pressure of the hydrogen gas at the fuel electrode is delayed further.

Therefore, there may be a case where a pressure difference grows excessively as shown in FIG. 3 between the air electrode where the pressure falls off quickly and the fuel electrode where the pressure falls off gently. If a value of the pressure difference exceeds an allowable limit, there may be a case where an electrolyte of the fuel cell is deteriorated. Here, in order to prevent a large pressure difference, it is conceivable to provide another purge valve of a large flow rate separately for stopping the fuel cell. However, such a purge valve incurs a cost increase and acceleration of the drop in the gas pressure as well. Accordingly, it may be difficult to achieve a state to stop the oxidant electrode prior to the fuel electrode.

Therefore, in the present invention, supply of the fuel gas is stopped when the judgment for a start of stopping procedures for the fuel cell takes place while the purge valve is fully opened or power generation is continued. Meanwhile, the oxidant gas is continuously supplied so as to continue pressure control such that the oxidant gas pressure traces the variation of the fuel gas pressure. In this way, the pressure difference of the gas pressure between the fuel electrode and the oxidant electrode is maintained within a maximum value of an allowable pressure difference.

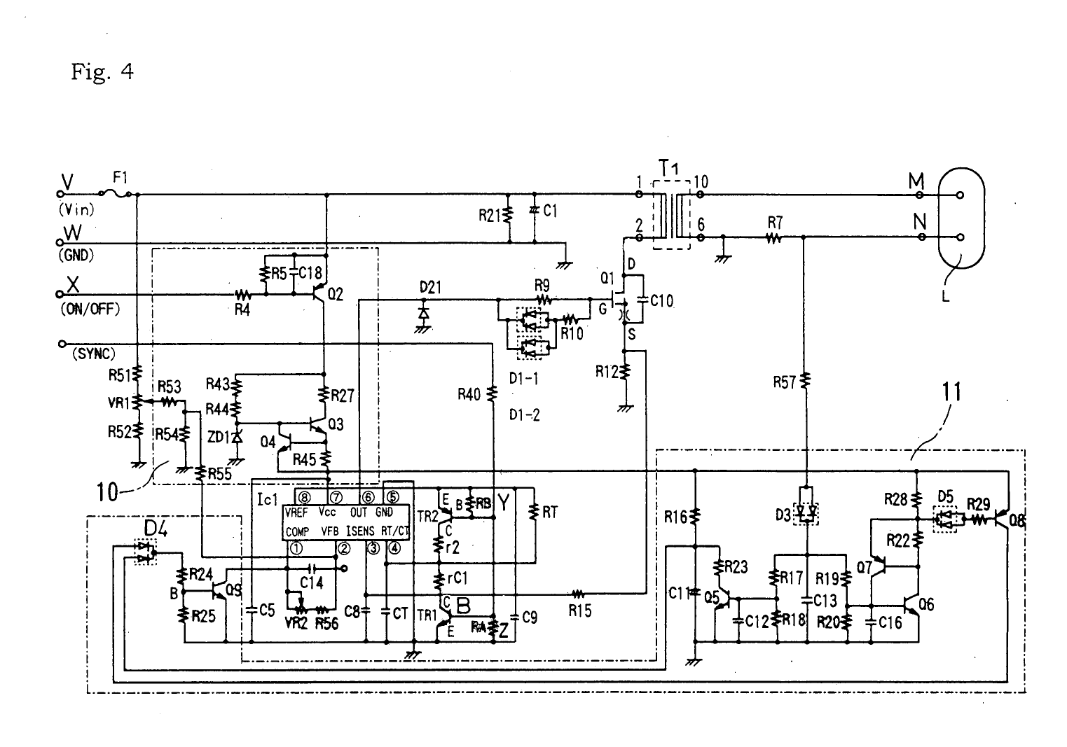

FIG. 4 is a timing chart showing aspects of variations of pressure at a fuel electrode and pressure at an air electrode with time in the event of stopping a fuel cell by a control device for a fuel cell according to the present invention. In FIG. 4, let us assume that a condition for judging a start of procedures for stopping the fuel cell occurs at a time point t0 when the fuel cell is in operation, for example. The controller 214 closes the variable valve 204 immediately to stop supply of the fuel gas (hydrogen); meanwhile, the controller 214 fully opens the purge valve 206. Simultaneously, the supply of the air from the compressor 203 is continued and an open angle of the throttle 205 is adjusted such that air pressure at the air electrode traces a variation of hydrogen pressure at the fuel electrode. Moreover, when the hydrogen pressure reaches a sum of atmospheric pressure and a maximum value of an allowable pressure difference (α) (such a time point is referred to as a time point t1), the compressor 203 is stopped and the throttle 205 is fully opened, whereby the air pressure is controlled to be equal to the atmospheric pressure.

In this way, it is possible to prevent deterioration of the electrolyte owing to an excessive pressure difference between the oxidant electrode and the fuel electrode. Moreover, it is also possible to prevent gradual deterioration of the electrolyte attributable to a variation of distribution of electric current density caused by an increase in internal resistance of the cell owing to formation of an oxide coating by excessive oxygen.

(First Embodiment)

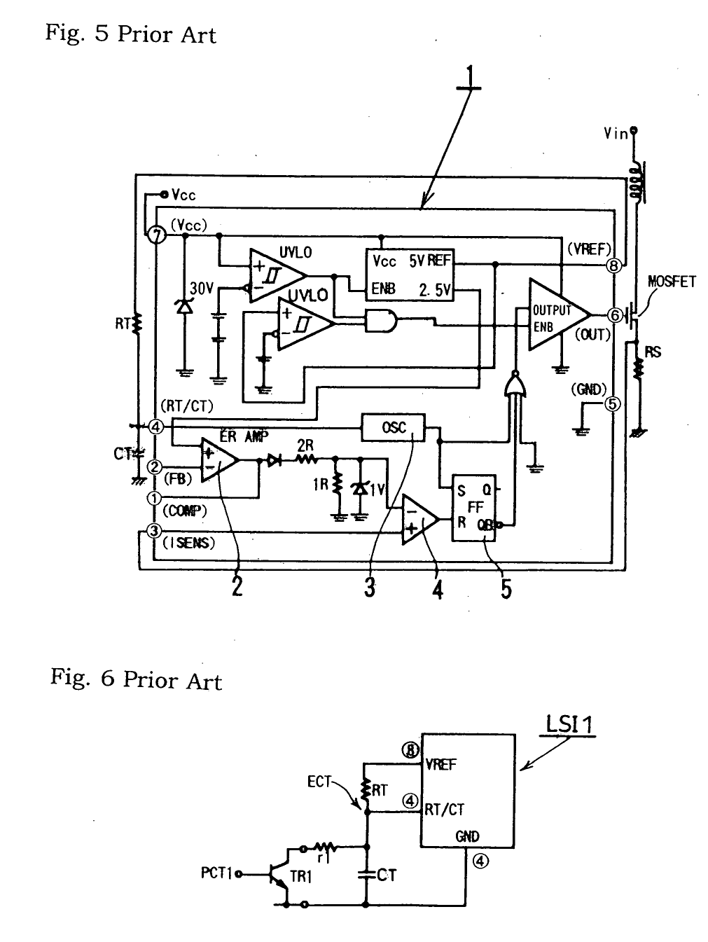

Next, description will be made in detail regarding an operation of a first embodiment in the constitution shown in FIG. 1 and FIG. 2 with reference to flowcharts of FIG. 5, FIG. 6 and FIG. 8. FIG. 6 is a general flowchart, which is executed by the controller 214 in each given time period (at every 10 ms, for example).

First, in Step S501, judgment is made as to whether procedures for stopping a fuel cell are started or not. When it is not in a state to stop the fuel cell, then normal operation control is performed in Step S502 and then the operation is terminated. In the normal operation control, for example, the hydrogen gas pressure and/or the hydrogen gas flow rate and the air pressure and/or the air flow rate relevant thereto for generating electric power (the electric current) by use of the fuel cell stack 201, which is required by the driving unit 209, are calculated. Moreover, the compressor 203, the throttle 205 and the variable valve 204 are controlled so as to constitute these pressure values and/or flow rates.

If the judgment is made to start the procedures for stopping the fuel cell in Step S501, then hydrogen control is stopped in Step S503. Subsequently, in Step S504, a detected value is retrieved from the pressure sensor 211 for detecting the hydrogen pressure at the fuel electrode inlet. Then, the retrieved hydrogen pressure is compared with a predetermined value.

Such a predetermined value refers to the sum of the atmospheric pressure and the maximum value of the allowable pressure difference a of the gas pressure at the fuel electrode and the gas pressure at the air electrode (the oxidant electrode). Here, the maximum value of the allowable pressure difference a is a value determined in accordance with a structure of the fuel cell, a material and a structure of the electrolyte, and the like. In a case of a fuel cell stack using a solid polymer electrolyte, the maximum value of the allowable pressure difference a is usually a smaller value as compared to the atmospheric pressure.

If the hydrogen pressure is judged as greater than the predetermined value in Step S504, then the operation proceeds to Step S505 to continue control of the pressure and the flow rate at the air electrode, and then the operation is terminated.

If the hydrogen pressure is not judged as greater than the predetermined value in Step S504, then the operation proceeds to Step S506 to stop supply of the air and the pressure control, and then the operation is terminated.

FIG. 6 is a detailed flowchart showing contents of the procedure for stopping the hydrogen control in Step S503 of FIG. 5.

In Step S601, a control signal for closing the variable valve 204 is issued to stop the hydrogen supply. In Step S602, the hydrogen pressure at the fuel electrode 201b is detected by the pressure sensor 211. In Step S603, a required generation amount of electricity relevant to the detected hydrogen pressure is calculated.

Here, an equivalent weight of the hydrogen is calculated based on the product of a volume of paths for the hydrogen gas downstream the variable valve 204 and the hydrogen gas pressure. Based on the equivalent weight of the hydrogen, a relation between the hydrogen gas pressure and the required generation amount of electricity is calculated in advance. Thereafter, a map of the relation is stored in the controller 214 in advance, such that the required generation amount of electricity is increased as the hydrogen pressure is increased in that relation. Accordingly, the required generation amount of electricity can be calculated with reference to the map.

Meanwhile, in a system including control for calculating the hydrogen pressure in response to the generation amount of electricity during normal power generation, it is also possible to adopt a constitution of inverse calculation by use of the regular calculating method.

In Step S604, the purge valve is fully opened. Accordingly, the subroutine process is completed and the operation returns to the general flowchart.

FIG. 8 is a detailed flowchart showing contents of the procedure for continuing the air control in Step S505 of FIG. 5.

In Step S801, an air flow rate required for power generation is calculated based on the required generation amount of electricity calculated in Step S503. In Step S802, the actual air flow rate is controlled to be aligned with the calculated value. In Step S803, the air pressure is controlled so as to trace the hydrogen pressure. Accordingly, subroutine process is completed and the operation returns to the general flowchart.

(Second Embodiment)

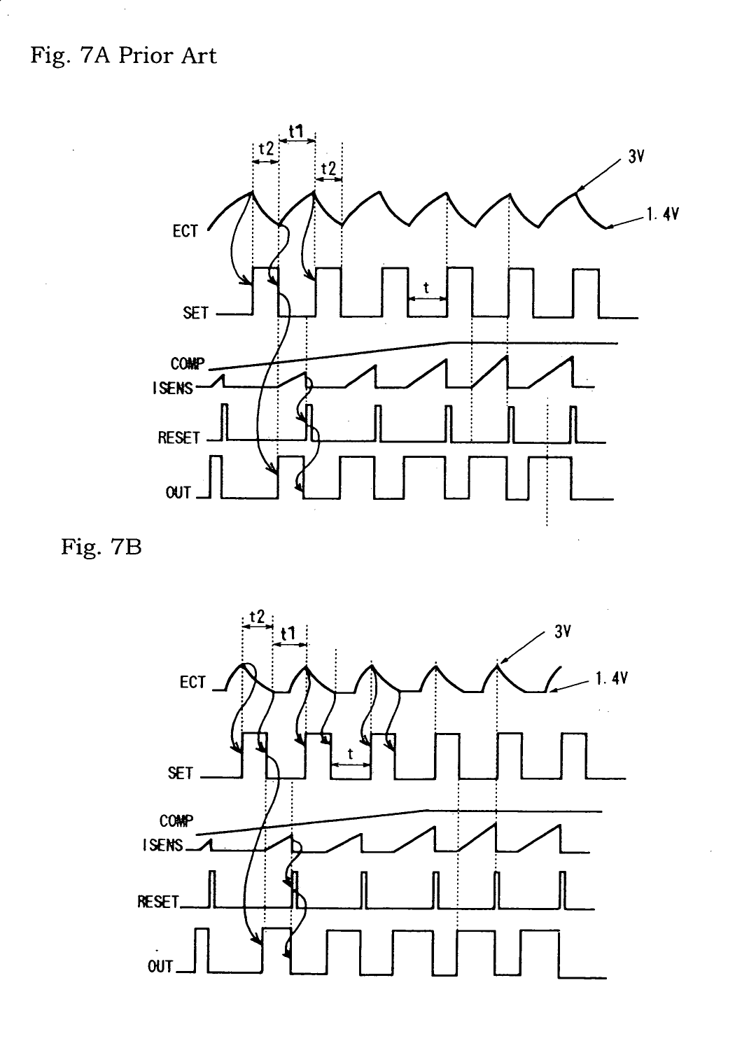

Next, description will be made in detail regarding an operation of a second embodiment in the constitution shown in FIG. 1 and FIG. 2 with reference to flowcharts of FIG. 5, FIG. 7 and FIG. 8.

Since FIG. 5 and FIG. 8 are similar to the first embodiment, description will be only made regarding FIG. 7.

FIG. 7 is a detailed flowchart showing contents of the procedure for stopping the hydrogen control in Step S503 of FIG. 5.

In Step S701, a control signal for closing the variable valve 204 is issued to stop the hydrogen supply. In Step S702, the hydrogen pressure at the fuel electrode 201b is detected by the pressure sensor 211.

In Step S703, a required generation amount of electricity relevant to the detected hydrogen pressure is calculated by means of inverse calculation with reference to a map used in a normal operation. In Step S704, a command is outputted to the driving unit 209 for taking out the required generation amount of electricity calculated in Step S703 as electric power, and then the procedure is completed.

Here, the hydrogen pressure at the fuel electrode is reduced by discharging the gas with the purge valve in the first embodiment. Meanwhile, the hydrogen pressure is reduced by power generation in response to the hydrogen pressure in the second embodiment. However, it is possible to carry out the both modes simultaneously.

Moreover, in the both embodiments, the flow rate at the air electrode is calculated by use of the required generation amount of electricity relevant to the actual pressure of the hydrogen. However, the flow rate at the air electrode may be defined as a predetermined value instead. Such a predetermined value may be appropriately defined as a flow rate sufficient for controlling the air pressure.

According to the foregoing embodiments, the control device includes the fuel cell stopping procedure start judgment unit 101 for judging a start of procedures for stopping a fuel cell, the fuel electrode gas controlling unit 102 for controlling fuel gas at a fuel electrode toward a stopping state based on an output from the fuel cell stopping procedure start judgment unit 101, the gas pressure detecting unit 103 for detecting gas pressure at the fuel electrode, and the oxidant electrode gas controlling unit 104 for controlling gas pressure at an oxidant electrode such that a difference between the gas pressure at the oxidant electrode and the gas pressure at the fuel electrode falls within a maximum value of an allowable pressure difference based on an output from the gas pressure detecting unit 103 and the output from the fuel cell stopping procedure start judgment unit 101, and for controlling the gas pressure at the oxidant electrode to atmospheric pressure after the gas pressure detected by the gas pressure detecting unit 103 reaches a sum of the atmospheric pressure and the maximum value of the allowable pressure difference. Accordingly, it is possible to stop the fuel cell promptly while preventing destruction of an electrolyte attributable to a pressure difference between the gas pressure on the fuel electrode side and the gas pressure on the oxidant electrode side.

Moreover, the control device adopts the constitution for controlling the gas pressure on the oxidant electrode side down to the atmospheric pressure after the fuel gas pressure reaches the sum of the atmospheric pressure and the maximum value of the allowable pressure difference. Accordingly, it is possible to surely prevent the pressure difference from exceeding the maximum value of the allowable pressure difference after stopping the control by setting the gas pressure at the oxidant electrode down to the atmospheric pressure. In addition, it is possible to prevent gradual deterioration of the electrolyte attributable to a variation of distribution of electric current density caused by an increase in internal resistance of the cell owing to formation of an oxide coating by excessive oxygen, by means of setting the gas control on the oxidant electrode side to the atmospheric pressure earlier than the fuel electrode side.

Moreover, according to the first embodiment, the fuel electrode gas controlling unit 102 is a unit designed to stop supply of the fuel gas and to open an exhaust valve for discharging the fuel gas outward, when the fuel cell stopping procedure start judgment unit 101 determines to start the stopping procedures. Meanwhile, the oxidant electrode gas controlling unit 104 is a unit designed to continue supply of the oxidant gas and to allow the pressure of the oxidant gas to trace the pressure of the fuel gas, when the fuel cell stopping procedure start judgment unit 101 determines to start the stopping procedures. Therefore, when the judgment to start the procedures for stopping the fuel cell takes place, it is possible to promote a drop in the fuel gas pressure by opening the exhaust valve and to surely control the pressure difference between the gas pressure on the fuel electrode side and the gas pressure on the oxidant electrode side to be maintained within a predetermined range.

Moreover, according to the second embodiment, the fuel electrode gas controlling unit 102 is a unit designed to stop supply of the fuel gas and to reduce the gas pressure at the fuel electrode by means of continuing power generation when the fuel cell stopping procedure start judgment unit 101 determines to start the stopping procedures. Meanwhile, the oxidant electrode gas controlling unit 104 is a unit designed to continue supply of the oxidant gas and to allow the pressure of the oxidant gas to trace the pressure of the fuel gas when the fuel cell stopping procedure start judgment unit 101 determines to start the stopping procedures. Therefore, the fuel gas can be consumed by continuing power generation, whereby it is possible to promote a drop in the fuel gas pressure by continuing power generation and to retrieve generation of electric power out of the fuel gas.

Moreover, according to the first embodiment, the oxidant electrode gas controlling unit 104 is a unit designed to continue supply of the oxidant gas relevant to a predetermined generation amount of electricity of the fuel cell when the fuel cell stopping procedure start judgment unit 101 determines to start the stopping procedures. Accordingly, it is possible to continue supplying the oxidant gas in just proportion with a simple method in the course of the stopping procedures, and to control the pressure to the required values as well.

Furthermore, according to the first embodiment, the predetermined generation amount of electricity can be set up in response to the pressure of the fuel gas in the event that the fuel cell stopping procedure start judgment unit 101 determines to start the stopping procedures. Accordingly, it is possible to stop the fuel cell promptly while minimizing the time for continuing power generation.

Japanese Patent Application No. 2002-8762 is expressly incorporated herein by reference in its entirety.

1. A control device for a fuel cell, comprising:
a fuel cell stopping procedure start judgment unit for judging a start of procedures for stopping a fuel cell;
a fuel electrode gas controlling unit for controlling fuel gas at a fuel electrode toward a stopping state based on an output from the fuel cell stopping procedure start judgment unit;
a gas pressure detecting unit for detecting gas pressure at the fuel electrode; and
an oxidant electrode gas controlling unit for controlling gas pressure at an oxidant electrode such that a difference between the gas pressure at the oxidant electrode and the gas pressure at the fuel electrode falls within a maximum value of an allowable pressure difference based on an output from the gas pressure detecting unit and the output from the fuel cell stopping procedure start judgment unit, and for controlling the gas pressure at the oxidant electrode to atmospheric pressure after the gas pressure detected by the gas pressure detecting unit reaches a sum of the atmospheric pressure and the maximum value of the allowable pressure difference.

2. The control device for a fuel cell according to claim 1,
wherein the fuel electrode gas controlling unit is to stop supply of the fuel gas and to open an exhaust valve for discharging the fuel gas outward, when the fuel cell stopping procedure start judgment unit determines to start the stopping procedures, and
the oxidant electrode gas controlling unit is a unit designed to continue supply of the oxidant gas and to allow the pressure of the oxidant gas to trace the pressure of the fuel gas, when the fuel cell stopping procedure start judgment unit determines to start the stopping procedures.

3. The control device for a fuel cell according to claim 1,
wherein the fuel electrode gas controlling unit is to stop supply of the fuel gas and to reduce the gas pressure at the fuel electrode by means of continuing power generation, when the fuel cell stopping procedure start judgment unit determines to start the stopping procedures, and
the oxidant electrode gas controlling unit is a unit designed to continue supply of the oxidant gas and to allow the pressure of the oxidant gas to trace the pressure of the fuel gas, when the fuel cell stopping procedure start judgment unit determines to start the stopping procedures.

4. The control device for a fuel cell according to claim 2, wherein the oxidant electrode gas controlling unit is to continue supply of the oxidant gas relevant to a predetermined generation amount of electricity of the fuel cell when the fuel cell stopping procedure start judgment unit determines to start the stopping procedures.

5. The control device for a fuel cell according to claim 4, wherein the predetermined generation amount of electricity is set in response to the pressure of the fuel gas at a time point when the fuel cell stopping procedure start judgment unit determines to start the stopping procedures.
